(19) United States
(12) Patent Application Publication
(10) Pub. No.: US 2002/0162434 A1
(43) Pub. Date: Nov. 7, 2002

(54) Food processing device

(76) Inventor: Roberto Aldo Acosta, Pcia. De Buenos Aires (AR)

Correspondence Address: DARBY & DARBY P.C., 805 Third Avenue, New York, NY, 10022, US

(21) Appl. No.: 09/871,246

(22) Filed: May 31, 2001

(30) Foreign Application Priority Data
May 7, 2001 (AR) P01 01 02157

(51) Int. Cl. B26D 7/00; B26D 3/00

(52) U.S. Cl. 83/13; 83/932; 83/167

(57) ABSTRACT

A food-processing device for cutting food products such as potatoes in revolution shapes to make a so known Noisette Potatoes. The device comprises a cutting module including a frame to supports a plurality of rotating blades. The rotating blades are within respective cutting sectors from which are cutted the spherical portions. A grid having stationary blades defining a plurality of quadrangular cutting sector. The rotating blades are connected to a set of gears mounted to the frames and connected to action means for rotation movement. The module is mounted on racks, which are connected to the gears and a lever, which acts over a pressure body. The pressure body pushes the product to be cutted.

### FIELD OF THE INVENTION

The present inventions relates to a device for processing foods and more particularly it relates to a device for cutting a shaping food products such as potatoes, carrots, cheese, sweet potatoes, fruits such as apples, peaches, and the similar, and most preferably this invention relates to a device for cutting potatoes into spherical shapes to make a so known Noisette Potatoes. However, the present invention can be used with several food products such as cheese, fruits and so to make spherical or revolution pieces from said food product for meal decoration.

For the purpose of this application the terms “revolution pieces” or revolution shapes” relates to a piece of food that is obtained trough cut by a curved or angled rotary blade rotating on a rotation axis passing through respective ends of the blade or through a projection of such ends.

### BACKGROUND OF THE INVENTION

Since the making of noissette potatoes is a time demanding task, there have being always a need for a device to cut and shape several noissette potatoes in just one step. There is widely known in the art a hand device for cutting and shaping noissette potatoes. This hand device can only produce a single noissette potato at the time. The hand device consists of a grip whose end comprises a kind of a semi spherical spoon with a cutting edge. As stated above this implement can only provide a single noissette potato and besides it is unable to conform a complete spherical piece because of the form of the semi spherical spoon. On the other hand, this implement is intended for domestic use, however since there is no other device to perform such task it is widely used in restaurants, hotels, take away houses, and so, where large quantities of potatoes are to be made. Indubitably, in such places the production of noissette potatoes must rely on the skills and expertise of the cook consuming valuable time and notoriously delaying the preparation of meals.

### SUMMARY OF THE INVENTION

In order to solve the drawbacks of the device of the prior art, the present invention was developed to perform mostly perfect spherical noissette potatoes enhancing the production of such potato. Consequently, the device of the present invention bestows the advantage of performing a systemized noissette potato manufacture and optimizes the tasks of the kitchen staff in charge of the meals. All of the above decreases the time consuming tasks of making noissette potatoes from whole potatoes.

Therefore is an object of the present invention to provide a cut and shape device for potatoes and similar products to perform spherical portions out of said products such as noissette potatoes, said device comprising a cutting module including a frame which supports at least a first spinning or rotation blade hosted inside of a cutting portion that cuts a portions of a whole product with said spinning or rotation blade. Said module includes rotation means connected to said spinning blade and said module is connected to an operation mechanism of the device.

Is another object of the present invention to provide a method for making noissette potatoes using the device of the present invention.

### BRIEF DESCRIPTION OF THE DRAWINGS

Preferred features of the present invention will now be described with reference to the accompanying drawings in which:

FIG. 1 is a top view illustrating the cutting module according to the preferred embodiment of the device of the present invention;

FIG. 2 is a front view of an operation mechanism of the cutting module of FIG. 1 in a first position of use and also showing said module included within said operation mechanism;

FIG. 3 is a front view of a second position of the operation mechanism including the cutting module of FIG. 2;

FIG. 4 is a side view of the working position of the operation mechanism including the cutting module of FIG. 2;

FIG. 5 is a perspective view illustrating a portion of a sliced product obtained by the device of the present invention.

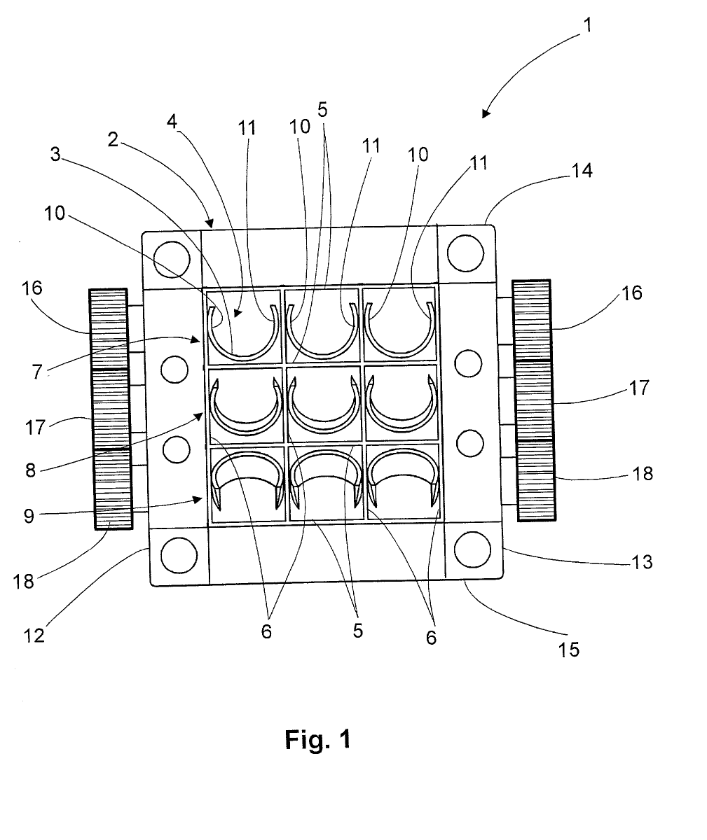

Referring now to FIG. 1 the device of the present invention comprises a module 1 including a frame 2 housing a plurality of spherical cutting blades. The spherical cutting blades defines a horse shoe form which cuts in a spherical form the respective portions of the whole product, hence producing the noissette potato.

The blades 3 comprising a rotation axis extending diametrically across the ring. At least one of facing side edges of the blades 3 includes a cutting edge according to the direction of rotation. However, since the blades 3 rotate in either direction during the operation, the cutting edges are included in both facing sides edges.

Each one of the blades 3 are placed in respective cutting sectors 4 in which the portions of the whole product will be placed from which will become the spherical form pieces. Said cutting sectors 4 have a quadrilateral or four-sided form and are perpendicular to the plane defined by the frame 2. The cutting sector 4 includes an upper sharpen edge. The cutting sector 4 is defined by a set of stationary cutting blades 5, 6, forming a cutting grid wherein quadrangular units of the grid defining rows of cutting sectors 7, 8 and 9. Each of said rows of cutting sectors 7-9 extending between opposite sides 12, 13 from frame 2. The row 7 is adjacent to the side 14, the row 8 is a central row, and row 9 is adjacent to the side 15 of said frame 2.

According to a particular embodiment of the present invention the rows 7-9 includes a set of four blades 3 each one defining nine cutting sectors 4. The geometrical axis of rotation of each blade 3 passes through respective facing ends 10, 11, of each of said blades 3 or at least their projections. The ends 10 of the blades adjacent to the side 12 of the frame 2 on one side and the ends 11 of the blades adjacent to the side 13 of said frame on the other are connected to respective rotation means. Gears connected to each other forming a set of gears define the rotation means.

Respective axes are passing through sides 12 and 13 from frame 2 projected from ends 10 of the blades 3 adjacent to said sides 12 and 13, being said axis connected to respective gears. On the other hand, the ends 10 and 11 of blades 3 adjacent to sides 12 and 13 respectively, from the frame 2, are connected by an axis passing through respective cutting blades 6 to the ends 10, 11 of the middle blades 3. In other words, the ones placed between the blades 3 are adjacent to the side 12 and 13 of the module.

First gears 16 defined in each of the set o gears corresponding to row 7 are connected to an operation mechanism of the module 1. Hence, defining first gears of gears 17 and 18 corresponding to the cutting rows 8 and 9.

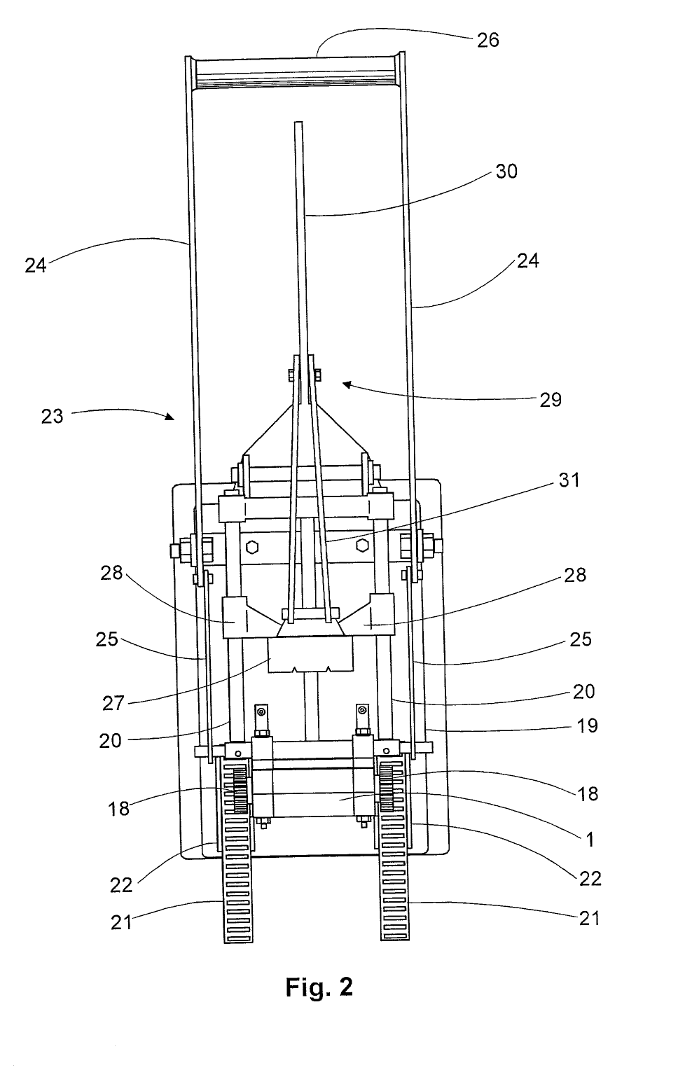

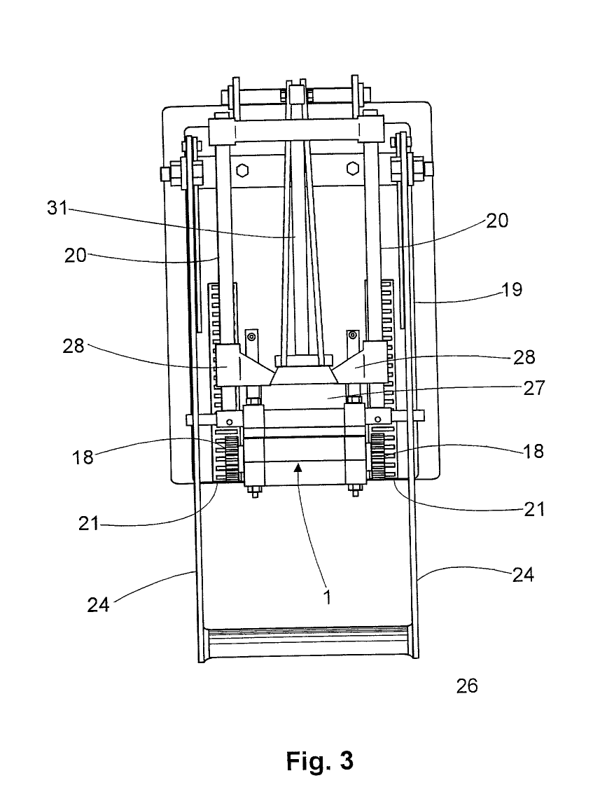

As stated above, referring to FIGS. 2-4, in order to operate the module 1, it comprises a base 19 in which the pieces of said operation mechanism are mounted and said base and preferably mounted on a supporting surface such as a wall. Said mechanism comprises a pair of side and parallel columns 20, in which the module 1 is mounted in the lower end. The leading gears 16 of the module 1 are connected to respective racks 21 slidable engage to respective guides 22 mounted to the base 19. By means of a first lever mechanism 23, formed by a pair of upper arms 24 and lower arms 25 articulated between each other, activates de up and down displacement of the racks 21 accordingly, as mentioned below. The arms 24 are joined in the upper end by a grip 26 that activates the lever mechanism 23 whilst the lower arms 25 are joined to said racks 21.

On the other hand, this operating mechanism comprises a pressure body 27 whose function is to pressure the product to be cutted by means of the stationary cutting blades 5 and 6 in the module 1. The inside face of the pressure body comprises concavities allowing a stable support of the product. Said pressure body 27 is slidable connected to the columns 25 by means of respective side supports 28 which are mounted in the upper part by a second lever mechanism 29. A pair of arms 31 connected to the pressure body 27 by a lower part defines the second lever mechanism.

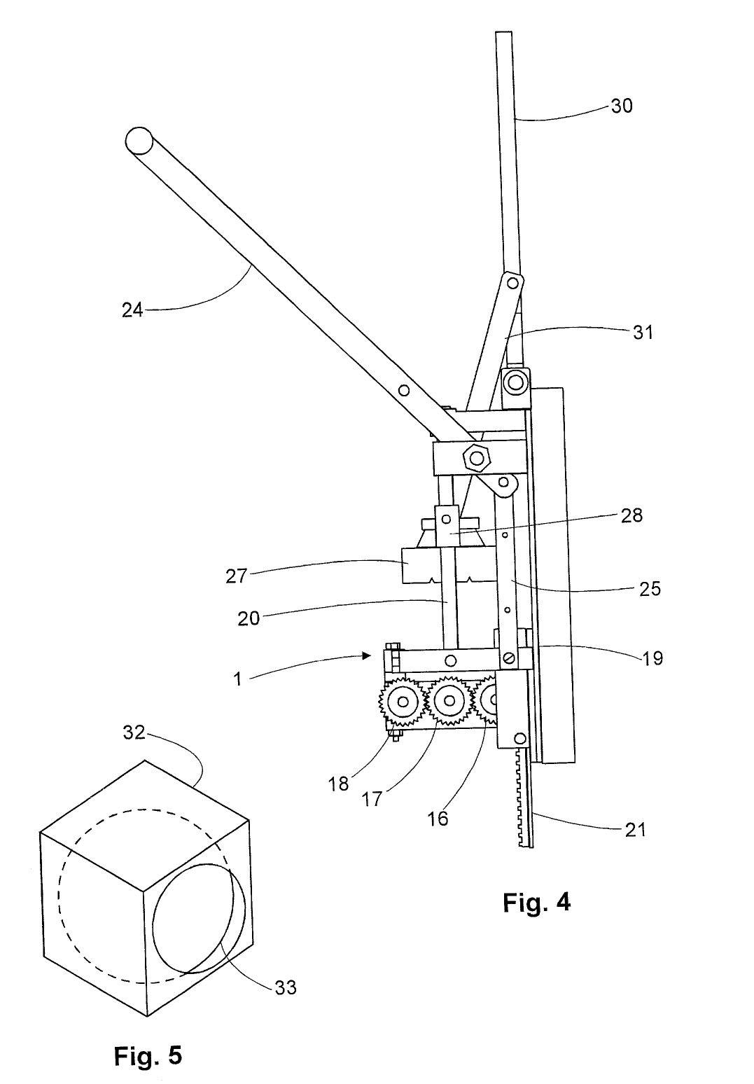

Referring now to FIGS. 1 and 4 a description follows on how the device of the present invention is to be operated to make noissette potatoes. In fact, the device is at a position previous to the initiation of the operation cycle. Once a whole potato is placed on the module 1 the arm 30 is lowered descending the body 27 which pushes the potato towards the blades 5 and 6 until said potato is completely cutted in cubic pieces, being each piece hosted in respectively cutting sectors 4. Afterwards, the lever mechanism 23 is activated lowering the arm 24 by means of the handle 26 and at the same time the racks 21 will actuate on the first gears 16 rotating all blades 3 and cutting all potatoes pieces into a spherical like noissette potato form.

Then, the arms 24 are lifted up to its starting position and afterwards the arm 30 is also lifted up to its starting position remaining the device able to start a new cutting cycle by placing a new whole potato on the module 1. At several repetitions of cutting cycles, each potato cutted with the blades 5 and 6 will push down the already cutted potato falling the cutted pieces into a collector device such as a tray placed beneath the module 1.

FIG. 5 shows a piece 32 of the potato in a cubic form cutted by stationary blades 5 and 6 in any cutting sector 4 of the module 1 and inside of said piece 32 a spherical portion 33 can be appreciated according to the action of the blade 3 to obtain noissette potatoes. As it would be understood, the portions of pieces 32 surrounding the spherical portion 33 are readily fractionable during the cutting process of said spherical portions or even when said potions drop down to the collecting tray.

Even when the aforementioned disclosure has been done according a specific embodiment wherein said rotating blades have a horse shoe like form, said rotating blades can have any suitable form in order to accomplish the cutting of revolution portions of potatoes (i.e. ring form and so) to produce noissette potatoes. However, as it will be apparent to any skilled in the art that the shapes of the blades can be of any suitable shaped in order to perform different shapes of cuts to obtain several forms of cutted food products to perform many decorated meals. Besides the above, other module 1 of same kind but with more or less cutting sectors can be readily replaced according to the size of the potato to be cutted or the product to be processed.

We claim

1. A food-processing device for food products in order to obtain pieces having a revolution shape, the device comprising:
a cutting module including a support frame;
at least one first rotating blade within a cutting sector of the support frame for cutting pieces of a product into portions by means of said first rotating blade;
actuating means for imparting rotational motion to at least one first rotating blade included in said module; and
an operation mechanism connected to said module.

2. The device of claim 1, wherein said at least one first rotating blade has a horse-shoe like shape and a geometrical rotating axis passes through facing ends of the horse-shoe and facing sides of said frame;
said rotating blade having at least one cutting edge.

3. The device of claim 1, wherein said at least one first rotating blade has a ring shape with a rotation axis extending diametrically across the ring.

4. The device of claim 1, wherein said cutting sector comprises stationary cutting blades for cutting pieces of product what pieces are to be then cut by rotating blades;
said stationary blades defining a quadrangular pattern with sharpened upper edges;
said rotating blades being mounted between a pair of facing stationary cutting blades, and
a rod projecting from a end of the rotating blade through an associated side of said frame and connected to said rotation actuating means.

5. The device of claim 1;
wherein the actuating means comprises at least one gear connected to said operation mechanism.

6. The device of claim 5, wherein said device comprises:
a plurality of said rotating blades;
a plurality of said stationary blades forming a cutting grid with each quadrangular unit of the grid being defined by a cutting sector;
wherein each rotary blade is located within a respective cutting sector;
the cutting grid defining cutting sector rows and a gear is connected to the rotary blade in a row, the gears of each row being connected to each other forming a set of gears;
wherein a first gear of the set of gears being connected to said operation mechanism.

7. The device of claim 6, wherein said operation mechanism includes a pair of parallel side columns wherein a module is attached to the lower ends of said columns;
said first gear being geared to a respective rack slidably mounted in a respective guide;
said rack being connected to a first action lever mechanism;
the operation mechanism including a pressure body for urging said stationary cutting blades to be cut,
said pressure body being slidably mounted to said pair of side columns by means of respective supports; and
a second lever mechanism being connected to said pressure body.

8. A method for cutting and shaping a food product, comprising the steps of:
a) placing a whole product into a module
b) cutting said product into block-shape pieces by means of stationary cutting blades
a) cutting said block-shape pieces into portions of revolution shape by means of the rotating blades
b) pushing the revolution shaped portions down into a collecting tray.
